(19) United States
(12) Patent Application Publication
(10) Pub. No.: US 2009/0022359 A1
(43) Pub. Date: Jan. 22, 2009

(54) Vegetation index image generation methods and systems

(75) Inventors: Yong Q. Kang, Elkton, MD (US); Young-Heon Jo, Camden, DE (US); Xiao-Hai Yan, Newark, DE (US)

Correspondence Address: RATNERPRESTIA, P.O. BOX 1596, WILMINGTON, DE, 19899, US

(73) Assignee: University of Delaware

(21) Appl. No.: 12/070,886

(22) Filed: Feb. 21, 2008

Related U.S. Application Data
(60) Provisional application No. 60/961,132, filed on Jul. 19, 2007.

(51) Int. Cl. G06K 9/00

(52) U.S. Cl. 382/100

(57) ABSTRACT

Methods and systems for generating a vegetation index image of a geographic region are disclosed by the present invention. The vegetation index image is generated by identifying one or more obscured locations within the geographic region, determining a vegetation index value for each location within the geographic region, replacing the determined vegetation index value for each obscured location with a predetermined replacement value for that location, and generating a vegetation index image based on the predetermined replacement values for the obscured locations and the determined vegetation index values for the non-obscured locations.

### CROSS-REFERENCE TO RELATED APPLICATIONS

This application is related to and claims the benefit of U.S. Provisional Application Ser. No. 60/961,132 entitled VEGETATION INDEX IMAGE GENERATION METHODS AND SYSTEMS filed on Jul. 19, 2007, the contents of which are incorporated herein by reference.

### GOVERNMENT FUNDING

The U.S. Government has a paid-up license in the present invention and the right in limited circumstances to require the patent owner to license others on reasonable terms as provided for by contract as awarded by the National Aeronautics and Space Administration under funding number NASA Space Grant (NNG05G092H).

### FIELD OF THE INVENTION

The present invention relates to generating a vegetation index image of a geographic region based upon satellite measurements and, more particularly, to methods and systems for reducing error in such images.

### BACKGROUND OF THE INVENTION

Photosynthesizing plants absorb visible light, especially light in the blue and red wavelength bands, but reflect and scatter light in the near-infrared (NIR) wavelength band. Thus, vegetation, such as green leaves, appears “dark” to red and blue wavelength band reflectance sensors and appears “bright” to NIR wavelength band sensors. Soil and water absorb and reflect red and NIR wavelength bands approximately equally. By contrast, clouds and snow reflect visible light and absorb NIR. Thus, clouds appear “bright” to red and blue wavelength band sensors and “dark” to NIR wavelength band sensors.

Vegetation indexes (VI's) are used to identify and study vegetation. Two common indexes are the Normalized Difference Vegetation Index (NDVI) and the Enhanced Vegetation Index (EVI). The NDVI is determined using the equation NDVI=(NIR−Red)/(NIR+Red), where Red and NIR are the spectral reflectance measurements acquired in thus, take on values between 0.0 and 1.0. Hence, the NDVI varies between −1.0 (clouds and snow) and +1.0 (dense forests). The EVI is determined by the equation EVI=[G*(NIR−Red)]/[NIR+(c*Red)−(c*Blue)+L], where G is a gain factor, c is an absorption factor, L is a canopy correction factor, and Red, Blue and NIR are the spectral reflectance measurements acquired in the red, blue and near-infrared wavelength bands, respectively. The NDVI and EVI complement each other in global vegetation studies and improve the detection of vegetation changes.

VI's are typically determined by using a ratio of reflected light wavelength bands from the planetary surface measured by satellite remote sensors. It is possible for locations on the planetary surface to be obstructed from view of the satellite remote sensors by clouds, fog, smoke, haze or poor satellite viewing angles, for example. These obstructions interfere with the detection of the wavelength bands reflected from the planetary surface, thereby reducing the accuracy of the determined VI's and images based upon the VI's.

Presently, composite VI images from 8, 16 or 30 day periods are typically used in an attempt to compensate for the effect of obstructed locations. In theory, increasing the number of days improves accuracy because it becomes less likely for the location to be obstructed for the entire period. Gathering measurements over several days to make one composite image decreases the temporal resolution of the VI images. Additionally, the effect of some obstructions may remain in these composite images (e.g., thin or shallow clouds).

### SUMMARY OF THE INVENTION

The present invention is directed to methods and systems for generating vegetation index images. The vegetation index images are generated by identifying one or more obscured locations within a geographic region, determining a vegetation index value for each location within the geographic region, replacing the determined vegetation index value for each obscured location with a predetermined replacement value for that location, and generating a vegetation index image based on the predetermined replacement values for the obscured locations and the determined vegetation index values for the non-obscured locations.

In exemplary embodiments of the present invention, obscured locations may be identified by obtaining a land surface temperature measurement for each location within the geographic region, determining a climate difference between the land surface temperature measurements and a corresponding climatology land surface temperature for each location within the geographic region, and identifying each location having a determined climate difference greater than a climatology tolerance value for that location as an obscured location. In other embodiments of the present invention, obscured locations may be identified by obtaining a land surface temperature measurement for each location within the geographic region, determining a previous difference between the land surface temperature measurements and a corresponding previous land surface temperature value for each of the locations within the geographic region, and identifying each location having a determined difference greater than a predefined difference value as an obscured location. Yet other embodiments of the present invention may use both methods simultaneously.

The predetermined replacement value for each of the identified obscured locations may be NO DATA, an estimate of a present vegetation index value for each obscured location based upon at least one previously determined vegetation index for that location, or an estimate of a present vegetation index value for each obscured location based upon one or more current vegetation index values for locations surrounding that obscured location.

In another exemplary embodiment of the present invention, a computer readable medium includes software configured to control a computer to implement a method for generating a vegetation index image. The vegetation index image is generated by identifying one or more obscured locations within the geographic region, determining a vegetation index value for each location within the geographic region, replacing the determined vegetation index value for each obscured location with a predetermined replacement value for that location, and generating a vegetation index image based on the predetermined replacement values for the obscured locations and the determined vegetation index values for the non-obscured locations.

Yet another exemplary embodiment of the present invention is a system for generating a vegetation index image of a geographic region. The system includes means for identifying one or more obscured locations within the geographic region, means for determining a vegetation index value for each location within the geographic region, means for replacing the determined vegetation index value for each obscured location with a predetermined replacement value for that location, and means for generating a vegetation index image based on the predetermined replacement values for the obscured locations and the determined vegetation index values for the non-obscured locations.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. This emphasizes that according to common practice, the various features of the drawings are not drawn to scale. On the contrary, the dimensions of the various features are arbitrarily expanded or reduced for clarity. Included in the drawings are the following figures:

FIG. 1 is an illustration depicting an exemplary satellite measurement system according to aspects of the present invention.

FIG. 2 is a block diagram depicting an exemplary computer architecture according to aspects of the present invention.

FIG. 3 is a flow chart depicting an exemplary method for generating a vegetation index image according to the present invention.

FIG. 4 is a flow chart depicting an exemplary method for identifying obscured locations within a geographic region according to the present invention.

FIGS. 5A and 5B are exemplary vegetation index images generated in accordance to the prior art.

FIGS. 5C and 5D are exemplary vegetation index images generated in accordance with the present invention.

### DETAILED DESCRIPTION OF THE INVENTION

The present invention may be used to generate a vegetation index (VI) image having fewer inaccuracies due to obstructions such as clouds, fog, smoke, and haze than VI images generated using composite data compiled over as long as 30-day time periods. Accordingly, as will be described below, more accurate VI images can be generated while maintaining temporal resolution.

FIG. 1 depicts an exemplary satellite 102 for observing a planetary surface 108. Satellite 102 has measurement equipment for obtaining measurements from the planetary surface 108 within a field of view 106. For example, this measurement equipment may be the National Oceanic and Atmospheric Administration's (NOAA) Advanced Very High Resolution Radiometer (AVHRR) platform or the National Aeronautics and Space Administration's (NASA) MODerate resolution Image Spectroradiometer (MODIS) platform. Satellite 102 also includes communications link 104 for transmitting measured data to a control station 110. For ease of obtaining and interpreting measured data, planetary surface 108 may be segmented into geographic regions 112 that each include a plurality of locations (represented by locations 114a-114n).

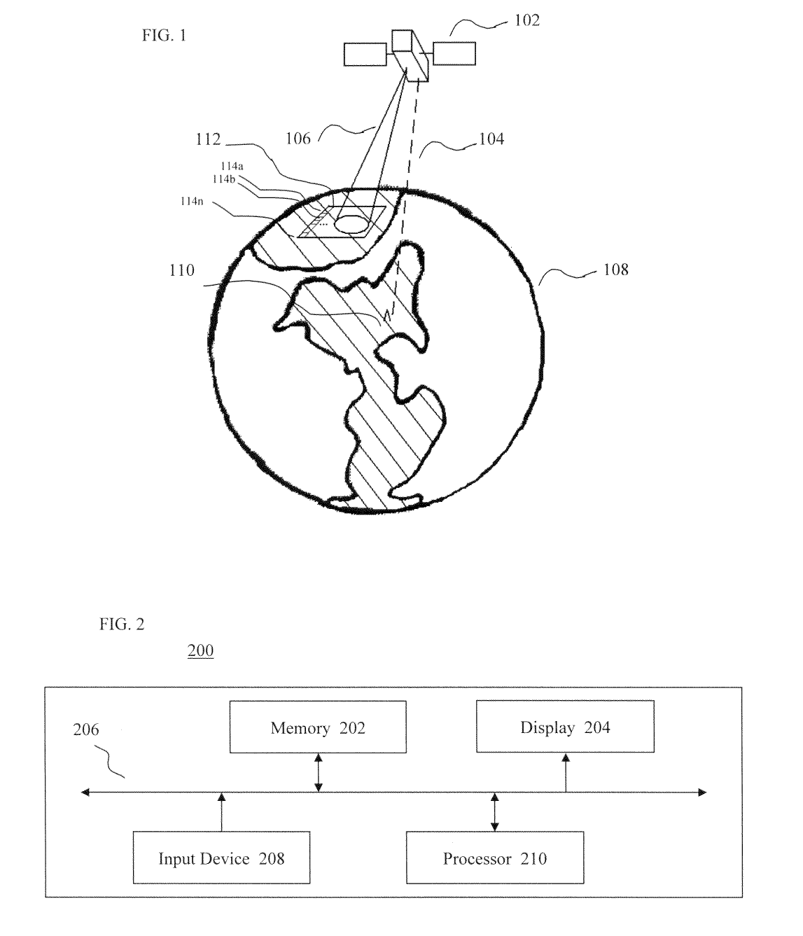

FIG. 2 depicts a computer 200 that includes a memory 202 for storing information, a display 204 for displaying information, an input device 208 for receiving information, and a processor 210 for processing information. Computer 200 also includes communication link 206 that enables processor 210 to access memory 202, receive input from input device 208, and display information on display 204. Computer 200 may receive information from satellite 102 (FIG. 1) via communications links 104 and 206 for processing by processor 210 and/or storage in memory 202. Input device 208 may be any standard computer input device such as a keyboard or CD-ROM. Further, communication link 206 may be connected to additional devices such as a local area network.

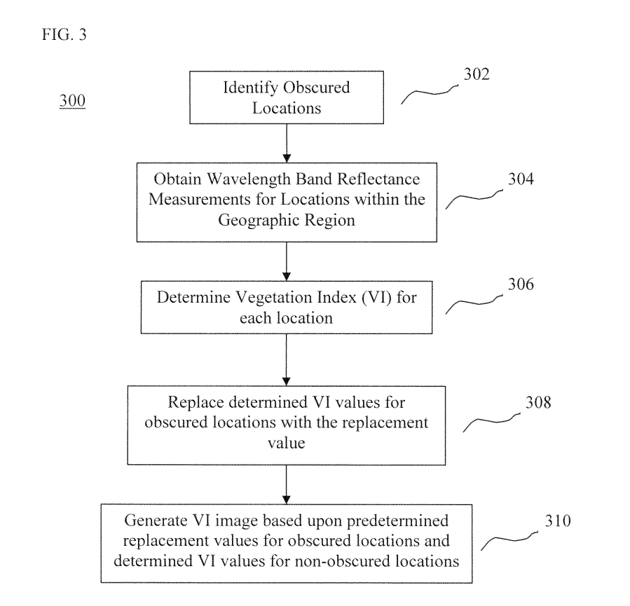

FIG. 3 depicts a flow chart 300 of an exemplary method for generating a vegetation index (VI) image of a geographic region. In step 302, obscured locations within the geographic region are identified. In an exemplary embodiment, obscured locations are identified by detecting anomalous Land Surface Temperature (LST) values, which is described below. In an exemplary embodiment, processor 210 (FIG. 2) identifies obscured locations based on information received from satellite 102 (FIG. 2). The information may be stored in memory 202 prior to processing by processor 210.

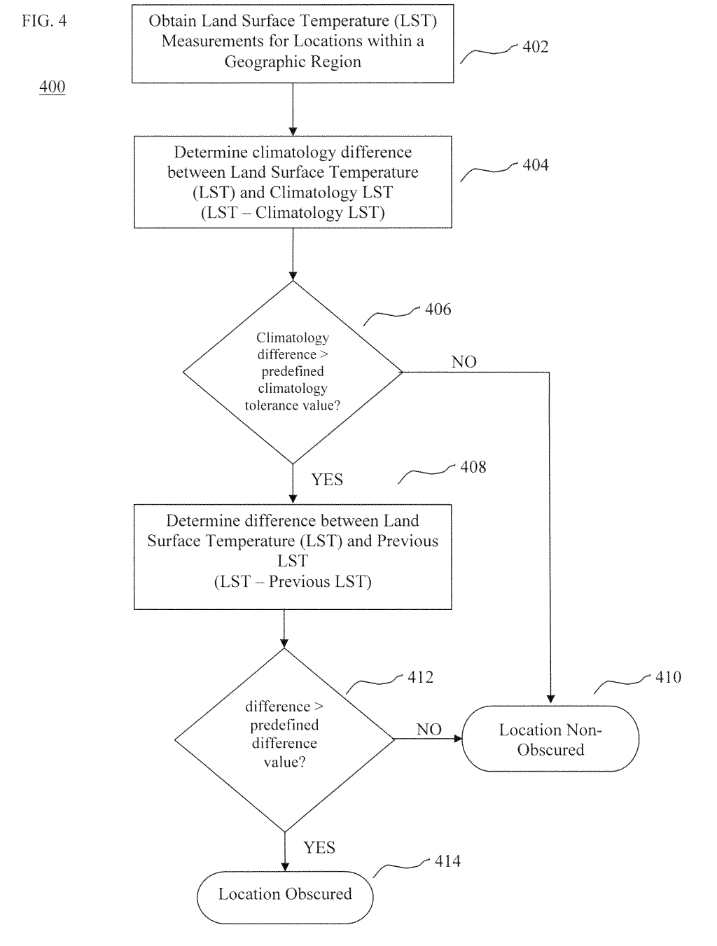

FIG. 4 depicts a flow chart 400 of an exemplary method for identifying obscured locations. In step 402, a measurement of the LST for each of the plurality of locations within the geographic region is obtained. In an exemplary embodiment, processor 210 processes information received from satellite 102 to obtain LST measurements.

In step 404, the difference between a climatology LST value and the LST measurement for each of the plurality of locations is determined. The climatology LST value is an expected LST value based upon historical climatological trends for the geographic region. In an exemplary embodiment, during step 404, processor 210 calculates the difference between the obtained LST measurement stored in memory 202 and the climatology LST value stored in memory 202 for each location 114 within the geographic region 112.

In step 406, the difference between the climatology LST and the measured LST is compared to a climatology tolerance value (e.g. 5 degrees Celsius). In an exemplary embodiment, if the difference between the climatology LST and the measured LST is greater than the climatology tolerance value, it may be suspected that the location is obscured and processing proceeds to step 408. Conversely, if the difference is less than the climatology tolerance value, it may be determined that the location is not obscured and processing proceeds to step 410 with that location identified as non-obscured. In an exemplary embodiment, during step 406, processor 210 compares the difference to a climatology tolerance value stored in memory 202 and identifies as obscured each location where the difference between the measured LST and the climatology LST is greater than the climatology tolerance value.

In step 408, the difference between the measured LST and a previously measured LST is determined for each location having a climatology difference greater than the climatology tolerance value. The previously measured LST is based upon the LST value from a previous day or composite period for that location. In an exemplary embodiment, processor 210 calculates the difference between the obtained LST measurement and the previously measured LST value stored in memory 202.

In step 412, the difference between the measured LST and the previously measured LST is compared to a predefined difference value (e.g., 10 degrees Celsius). In an exemplary embodiment, if the difference between the measured LST and the previously measured LST is greater than the predefined difference value, it may be determined that the location is obscured and processing proceeds to step 414 with that location identified as obscured. Conversely, if the difference is less than the predefined difference value, it may be determined that the location is not obscured and processing proceeds to step 410 with that location identified as non-obscured. In an exemplary embodiment, processor 210 compares the difference to the predefined difference value stored in memory 202 and identifies as obscured each location where the difference is greater than the predefined difference value.

Referring back to FIG. 3, once obscured locations are identified, the spectral reflectance measurements in the appropriate wavelength bands are obtained in step 304. For example, if NDVI is being determined, reflectance measurements in the red and near-infrared wavelength bands will be obtained in step 304. Alternatively, if EVI is being determined, reflectance measurements in the red, blue and near-infrared wavelength bands will be obtained in step 304. Appropriate wavelength band reflectance measurements for other VI's will be understood to one of skill in the art from the description herein. In an alternative exemplary embodiment, step 304 may be performed before identifying the obscured locations in step 302. In an exemplary embodiment, during step 304 processor 210 accesses the spectral reflectance measurements from memory 202.

In step 306, the spectral reflectance measurements are used to determine VI values for each location within the geographic region. For example, if NDVI values are to be determined, the equation NDVI=(NIR−Red)/(NIR+Red) is used, where Red and NIR stand for the spectral reflectance measurements acquired in the red and near-infrared wavelength bands, respectively. Similarly, if EVI values are to be determined, the equation EVI=[G*(NIR−Red)]/[NIR+(c*Red)−(c*Blue)+L] is used, where G is a gain factor, c is an absorption factor, L is a canopy correction factor, and Red, Blue and NIR stand for the spectral reflectance measurements acquired in the red, blue and near-infrared wavelength bands, respectively. In an exemplary embodiment, during step 306 processor 210 calculates the VI for each location 114 a-n within the geographic region 112.

In step 308, VI values for obscured locations are replaced with a replacement value, e.g., by processor 210. In an exemplary embodiment, the replacement value for each obscured location may be a unique value representing a lack of data (e.g., “NO DATA”). In an alternative exemplary embodiment, the replacement value for each obscured location may be an estimate based upon at least one previously determined vegetation index for that location. In yet another exemplary embodiment, the replacement value for each obscured location may be an estimate based upon one or more current vegetation index values for locations surrounding that obscured location. Other suitable methods for determining replacement values will be understood by one of skill in the art from the description herein.

In an exemplary embodiment, processor 210 may calculate each replacement value as an estimate based upon at least one previously determined vegetation index stored in memory 202 for that obscured location. Alternatively, processor 210 may calculate each replacement value as an estimate based upon one or more current vegetation index values stored in memory 202 for locations surrounding that obscured location. Processor 210 may store calculated replacement values to memory 202 for use in subsequent replacement of VI values for obscured locations.

In step 310, a VI image is generated based on the replacement values for the obscured locations and the determined vegetation index values for the non-obscured locations. In an exemplary embodiment, the VI image is generated on a display 204 (FIG. 2) or a color printer (not shown) by processor 210, with each location represented by one or more pixels in the generated VI image. The colors assigned to each location in the generated VI image correspond to the predetermined replacement value for obscured locations and the determined VI value for non-obscured locations. For example, shades of red and orange may represent poor VI values (low amount of foliage), shades of green may represent good VI values (high amount of foliage), and white may represent obscured locations where VI values have been replaced with NO DATA. Alternatively, obscured locations may be represented by the colors corresponding to the foliage levels of the replacement values.

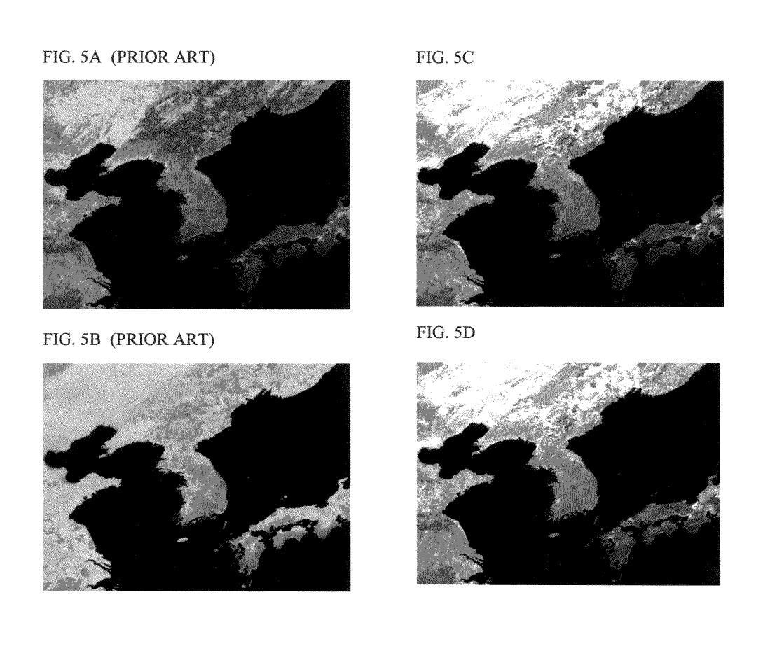

FIGS. 5A and 5B are exemplary VI images generated in accordance with the prior art. FIG. 5A is generated using maximum values of VI from an 8-day composite. FIG. 5B is similar to FIG. 5A but uses averaged values of VI from the 8-day composite. In FIGS. 5A and 5B, red and orange represent poor VI values and green represents good VI values. Much of the red and orange areas in FIGS. 5A and 5B, however, are known to be due to obstructions and are not accurate.

FIGS. 5C and 5D are exemplary VI images generated in accordance with the present invention and represent VI values for the same time period as FIGS. 5A and 5B. FIG. 5C is generated using maximum values of VI from the same 8-day composite as FIGS. 5A and 5B, but with obscured locations masked out (represented in white, e.g. for NO DATA). FIG. 5D is similar to FIG. 5C but uses averaged values from the 8-day composite.

It is contemplated that the methods previously described may be carried out within a computer instructed to perform these functions by means of a computer-readable medium. Such computer-readable media include integrated circuits, magnetic and optical storage media, as well as audio-frequency, radio frequency, and optical carrier waves.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for generating a vegetation index image of a geographic region having a plurality of locations, the method comprising the steps of:
identifying one or more obscured locations from the plurality of locations within the geographic region;
determining a vegetation index value for each of the plurality of locations within the geographic region;
replacing the determined vegetation index value for each of the identified obscured locations with a predetermined replacement value for that location; and
generating a vegetation index image based on the predetermined replacement values for the obscured locations and the determined vegetation index values for non-obscured locations.

2. The method according to claim 1, wherein the identifying step comprises the steps of:
obtaining land surface temperature measurements for a plurality of locations within the geographic region;
determining a difference between the land surface temperature measurements for each of the plurality of locations within the geographic region and a corresponding climatology land surface temperature; and
identifying as obscured each location having a determined difference greater than a climatology tolerance value for that location.

3. The method according to claim 2, wherein the climatology tolerance value is 5 degrees Celsius.

4. The method according to claim 1, wherein the identifying step comprises the steps of:
obtaining land surface temperature measurements for a plurality of locations within the geographic region;
determining a difference between the land surface temperature measurements for each of the plurality of locations within the geographic region and a corresponding previous land surface temperature value; and
identifying as obscured each location having a determined difference greater than a predefined difference value.

5. The method according to claim 4, wherein the predefined difference value is plus or minus 10 degrees Celsius.

6. The method according to claim 1, wherein the identifying step comprises the steps of:
obtaining land surface temperature measurements for a plurality of locations within the geographic region;
determining a climate difference between the land surface temperature measurements for each of the plurality of locations within the geographic region and a corresponding climatology land surface temperature;
determining a previous difference between the land surface temperature measurements for each of the plurality of locations within the geographic region and a corresponding previous land surface temperature value; and
identifying as obscured each location having a determined climate difference greater than a climatology tolerance value for that location and having a determined difference greater than a predefined difference value.

7. The method according to claim 1, wherein the predetermined replacement value for each of the identified obscured locations is NO DATA.

8. The method according to claim 1, wherein the predetermined replacement value for each of the identified obscured locations is an estimate of a present vegetation index value for each of the identified obscured locations based upon at least one previously determined vegetation index for that location.

9. The method according to claim 1, wherein the predetermined replacement value for each of the identified obscured locations is an estimate of a present vegetation index value for each of the identified obscured locations based upon one or more current vegetation index values for locations surrounding that obscured location.

10. The method according to claim 1 further comprising:
obtaining a plurality of light wavelength band reflectance measurements for each of the plurality of locations within the geographic region.

11. The method according to claim 1, wherein the generating step further comprises:
assigning colors corresponding to the vegetation index values within the geographic region.

12. The method according to claim 11, wherein the predetermined replacement value is assigned one or more unique colors.

13. The method according to claim 1, wherein the generating step further comprises:
displaying the vegetation index image on a display.

14. A computer readable medium including software that is configured to control a general purpose computer to implement a method for generating a vegetation index image of a geographic region having a plurality of locations, the method including the steps of:
identifying one or more obscured locations from the plurality of locations within the geographic region;
determining a vegetation index value for each of the plurality of locations within the geographic region;
replacing the determined vegetation index value for each of the identified obscured locations with a predetermined replacement value for that location; and
generating a vegetation index image based on the predetermined replacement values for the obscured locations and the determined vegetation index values for non-obscured locations.

15. The computer readable medium according to claim 14, wherein the identifying step comprises the steps of:
obtaining land surface temperature measurements for a plurality of locations within the geographic region;
determining a difference between the land surface temperature measurements for each of the plurality of locations within the geographic region and a corresponding climatology land surface temperature; and
identifying as obscured each location having a determined difference greater than a climatology tolerance value for that location.

16. The computer readable medium according to claim 15, wherein the climatology tolerance value is 5 degrees Celsius.

17. The computer readable medium according to claim 14, wherein the identifying step comprises the steps of:
obtaining land surface temperature measurements for a plurality of locations within the geographic region;
determining a difference between the land surface temperature measurements for each of the plurality of locations within the geographic region and a corresponding previous land surface temperature value; and
identifying as obscured each location having a determined difference greater than a predefined difference value.

18. The computer readable medium according to claim 17, wherein the predefined difference value is plus or minus 10 degrees Celsius.

19. The computer readable medium according to claim 14, wherein the identifying step comprises the steps of:
obtaining land surface temperature measurements for a plurality of locations within the geographic region;
determining a climate difference between the land surface temperature measurements for each of the plurality of locations within the geographic region and a corresponding climatology land surface temperature;
determining a previous difference between the land surface temperature measurements for each of the plurality of locations within the geographic region and a corresponding previous land surface temperature value; and
identifying as obscured each location having a determined climate difference greater than a climatology tolerance value for that location and having a determined difference greater than a predefined difference value.

20. A system for generating a vegetation index image of a geographic region having a plurality of locations, the system comprising:
means for identifying one or more obscured locations from the plurality of locations within the geographic region;
means for determining a vegetation index value for each of the plurality of locations within the geographic region;
means for replacing the determined vegetation index value for each of the identified obscured locations with a predetermined replacement value for that location; and
means for generating a vegetation index image based on the predetermined replacement values for the obscured locations and the determined vegetation index values for non-obscured locations.
